(19) United States
(12) Patent Application Publication
(10) Pub. No.: US 2022/0315478 A1
(43) Pub. Date: Oct. 6, 2022

(54) METHOD FOR PRODUCING POROUS GLASS MEMBER

(71) Applicant: NIPPON ELECTRIC GLASS CO., LTD., Otsu-shi, Shiga (JP)

(72) Inventor: Takashi AITOKU, Otsu-shi (JP)

(21) Appl. No.: 17/642,255

(22) PCT Filed: Oct. 29, 2020
(86) PCT No.: PCT/JP2020/040621

§ 371 Date: Mar. 11, 2022

(30) Foreign Application Priority Data
Nov. 11, 2019 (JP) 2019-203903

(51) Int. Cl. C03C 4/20; C03C 3/085

(52) U.S. Cl. CPC C03C 4/20; C03C 3/085

(57) ABSTRACT

Provided is a method for producing a porous glass member whereby excellent productivity can be achieved because of a high etching rate during acidic treatment and a porous glass member having excellent alkali resistance can be obtained. A method for producing a porous glass member includes the steps of: subjecting a glass base material containing, in terms of % by mole, 40 to 80% SiO₂, over 0 to 40% B₂O₃, 0 to 20% Li₂O, 0 to 20% NaₐO, 0 to 20% K₂O, over 0 to 10% TiO₂, over 0 to 20% ZrO₂, 0 to 10% Al₂O₃, and 0 to 20% RO (where R represents at least one selected from among Mg, Ca, Sr, and Ba) and having a molar ratio of Li₂O/Na₂O of 0 to 0.16 to thermal treatment to separate the glass base material into two phases; and removing one of the two phases with an acid.

### TECHNICAL FIELD

The present invention relates to methods for producing a porous glass member.

### BACKGROUND ART

Porous glass has a sharp pore distribution and a large specific surface area and also has thermal resistance and organic solvent resistance and, therefore, its use in a wide range of applications, including a separation membrane, a diffuser tube, an electrode material, and a catalyst support, is recently under consideration. These applications include use in an alkaline environment. In consideration of application to such use, porous glass needs to have alkali resistance. Alkali-resistant porous glass is produced by thermally treating a glass base material made of alkali borosilicate glass containing zirconia to separate it into two phases: a silica-rich phase and a boron oxide-rich phase and removing the boron oxide-rich phase with an acid (see, for example, Patent Literature 1).

### CITATION LIST

### Patent Literature

### [PTL 1]

### JP-B2-1617152

### SUMMARY OF INVENTION

### Technical Problem

However, the method for producing alkali-resistant porous glass described in Patent Literature 1 has a low etching rate during acidic treatment and therefore requires much time for the acidic treatment, which presents a problem of poor productivity.

In view of the above, the present invention has an object of providing a method for producing a porous glass member whereby excellent productivity can be achieved because of a high etching rate during acidic treatment and a porous glass member having excellent alkali resistance can be obtained.

### Solution to Problem

The inventor conducted intensive studies and, as a result, found that the above technical problem can be solved by strictly restricting the composition of a base material for a porous glass member.

Specifically, a method for producing a porous glass member according to the present invention includes the steps of:

subjecting a glass base material containing, in terms of % by mole, 40 to 80% SiO₂, over 0 to 40% B₂O₃, 0 to 20% Li₂O, 0 to 20% Na₂O, 0 to 20% K₂O, over 0 to 10% TiO₂, over 0 to 20% ZrO₂, 0 to 10% Al₂O₃, and 0 to 20% RO (where R represents at least one selected from among Mg, Ca, Sr, and Ba) and having a molar ratio of Li₂O/Na₂O of 0 to 0.16 to thermal treatment to separate the glass base material into two phases; and removing one of the two phases with an acid.

Herein, “x/y” means a value obtained by dividing the content of x by the content of y.

In the method for producing a porous glass member according to the present invention, the glass base material preferably has an aspect ratio of 2 to 1000. The aspect ratio can be calculated by the following equation.

Aspect ratio=(base area of the glass base material)^{1/2}/(thickness of the glass base material)

In the method for producing a porous glass member according to the present invention, a temperature for the thermal treatment is preferably 500 to 800° C.

A glass base material for a porous glass member according to the present invention contains, in terms of % by mole, 40 to 80% SiO₂, over 0 to 40% B₂O₃, 0 to 20% Li₂O, 0 to 20% Na₂O, 0 to 20% K₂O, over 0 to 10% TiO₂, over 0 to 20% ZrO₂, 0 to 10% Al₂O₃, and 0 to 20% RO (where R represents at least one selected from among Mg, Ca, Sr, and Ba) and has a molar ratio of Li₂O/Na₂O of 0 to 0.16.

A porous glass member according to the present invention contains, in terms of % by mass, 50 to 99% SiO₂, over 0 to 15% Na₂O, 0 to 5% K₂O, over 0 to 10% TiO₂, over 0 to 30% ZrO₂, over 0 to 15% Al₂O₃, and 0 to 5% RO (where R represents at least one selected from among Mg, Ca, Sr, and Ba).

### Advantageous Effects of Invention

The present invention enables provision of a method for producing a porous glass member whereby excellent productivity can be achieved because of a high etching rate during acidic treatment and a porous glass member having excellent alkali resistance can be obtained.

### DESCRIPTION OF EMBODIMENTS

A method for producing a porous glass member according to the present invention includes the steps of: subjecting a glass base material containing, in terms of % by mole, 40 to 80% SiO₂, over 0 to 40% B₂O3, 0 to 20% Li₂O, 0 to 20% Na₂O, 0 to 20% K₂O, over 0 to 10% TiO₂, over 0 to 20% ZrO₂, 0 to 10% Al₂O₃, and 0 to 20% RO (where R represents at least one selected from among Mg, Ca, Sr, and Ba) and having a molar ratio of Li₂O/Na₂O of 0 to 0.16 to thermal treatment to separate the glass base material into two phases; and removing one of the two phases with an acid.

The following description is given of the reasons why the content of each component of the glass base material is specified as above. In the following description of the respective contents of components, “%” refers to “% by mole” unless otherwise specified.

SiO₂ is a component that forms a glass network. The content of SiO₂ is 40 to 80%, preferably 45 to 75%, more preferably 47 to 65%, and particularly preferably 50 to 60%. If the content of SiO₂ is too small, the weather resistance and mechanical strength of the porous glass member tend to decrease. Additionally, in the production process, the amount of expansion due to hydration of silica gel is likely to be smaller than the amount of contraction due to elution of alkaline components, such as Na₂O, from a silica-rich phase, which makes it likely that the porous glass member cracks. On the other hand, if the content of SiO₂ is too large, phase separation is less likely to occur.

B₂O₃ is a component that forms a glass network and promotes phase separation. The content of B₂O₃ is over 0 to 40%, preferably 10 to 30%, and particularly preferably 15 to 25%. If the content of B₂O₃ is too small, the above effects are difficult to achieve. If the content of B₂O₃ is too large, the weather resistance of the glass base material is likely to decrease.

Li₂O is a component that decreases the melting temperature to improve meltability and also a component that promotes phase separation. The content of Li₂O is 0 to 20%, preferably 0 to 15%, more preferably 0.1 to 15%, still more preferably 0.1 to 10%, and particularly preferably 0.2 to 10%. If the content of Li₂O is too large, phase separation is less likely to occur contrariwise.

Na₂O is a component that decreases the melting temperature to improve meltability and also a component that promotes phase separation. The content of Na₂O is 0 to 20%, preferably over 0 to 20%, more preferably 3 to 15%, and particularly preferably 4 to 10%. If the content of Na₂O is too small, the above effects are difficult to achieve. On the other hand, if the content of Na₂O is too large, phase separation is less likely to occur contrariwise.

K₂O is a component that decreases the melting temperature to improve meltability and also a component that promotes phase separation. K₂O is also a component that increases the content of ZrO₂ in a silica-rich phase. Therefore, by containing K₂O in the glass base material, the content of ZrO₂ in the obtained porous glass member increases, so that the alkali resistance can be increased. The content of K₂O is 0 to 20%, preferably over 0 to 5%, and particularly preferably 0.3 to 3%. If the content of K₂O is too small, the above effects are difficult to achieve. On the other hand, if the content of K₂O is too large, phase separation is less likely to occur contrariwise.

The content of Li₂O+Na₂O+K₂O is preferably 0 to 20%, more preferably over 0 to 18%, still more preferably 2 to 15%, yet still more preferably 4 to 12%, and particularly preferably 5 to 10%. If the content of Li₂O+Na₂O+K₂O is too small, the melting temperature may increase to decrease meltability. In addition, phase separation is less likely to occur. If the content of Li₂O+Na₂O+K₂O is too large, phase separation is less likely to occur contrariwise. Herein, “x+y+ . . . ” means the total content of x, y, . . . which are components.

The ratio of (Li₂O+Na₂O+K₂O)/B₂O₃ is preferably 0.2 to 0.5, more preferably 0.29 to 0.45, still more preferably 0.31 to 0.42, and particularly preferably 0.33 to 0.42. Thus, in the production process, a balance is achieved between the amount of expansion due to hydration of silica gel and the amount of contraction due to elution of alkaline components from a silica-rich phase, which makes it less likely that the porous glass member cracks.

The ratio of Na₂O/B₂O₃ is preferably 0.1 to 0.5, more preferably 0.15 to 0.45, and particularly preferably 0.2 to 0.4. Thus, in the production process, a balance is achieved between the amount of expansion due to hydration of silica gel and the amount of contraction due to elution of Na₂O from a silica-rich phase, which makes it less likely that the porous glass member cracks.

The ratio of Li₂O/Na₂O is 0 to 0.16, preferably 0 to 0.13, and particularly preferably 0 to 0.10. Thus, clouding in the phase separation step (clouding due to uncontrollability of the phase separation behavior) can be reduced.

TiO₂ is a component that increases the etching rate of the glass base material during acidic treatment. The content of TiO₂ is over 0 to 10%, preferably 0.1 to 8%, more preferably 0.15 to 6%, and particularly preferably 0.5 to 6%. If the content of TiO₂ is too small, the above effect is difficult to achieve. On the other hand, if the content of TiO₂ is too large, the glass is likely to be colored and therefore decrease the visible light transmittance.

ZrO₂ is a component that increases the weather resistance of the glass base material and the alkali resistance of the porous glass member. The content of ZrO₂ is over 0 to 20%, preferably 2 to 15%, and particularly preferably 2.5 to 12%. If the content of ZrO₂ is too small, the above effects are difficult to achieve. On the other hand, if the content of ZrO₂ is too large, devitrification is likely to occur and phase separation is less likely to occur.

The ratio of SiO₂/ZrO₂ is preferably 0.04 to 50, more preferably 0.04 to 30, and particularly preferably 0.04 to 25. If the ratio of SiO₂/ZrO₂ is too small, the mechanical strength of the porous glass member is likely to decrease. On the other hand, if the ratio of SiO₂/ZrO₂ is too large, the alkali resistance of the porous glass member is likely to decrease.

TiO₂+ZrO₂ is preferably over 0 to 25%, more preferably 1 to 20%, and particularly preferably 3 to 20%. If TiO₂+ZrO₂ is too small, the alkali resistance of the porous glass member is likely to decrease. On the other hand, if TiO₂+ZrO₂ is too large, phase separation is less likely to occur.

Al₂O₃ is a component that increases the weather resistance and mechanical strength of the porous glass member. The content of Al₂O₃ is 0 to 10%, preferably 0.1 to 7%, and particularly preferably 1 to 5%. If the content of Al₂O₃ is too large, the melting temperature is likely to increase to decrease meltability.

RO (where R represents at least one selected from among Mg, Ca, Sr, and Ba) is a component that increases the content of ZrO₂ in a silica-rich phase. Therefore, by containing RO in the glass base material, the content of ZrO₂ in the obtained porous glass member increases, so that the alkali resistance can be increased. RO is also a component that increases the weather resistance of the porous glass member. The content of RO (i.e., the total content of MgO, CaO, SrO, and BaO) is 0 to 20%, preferably 1 to 17%, more preferably 3 to 15%, still more preferably 4 to 13%, yet still more preferably 5 to 12%, and particularly preferably 6.5 to 12%. If the content of RO is too large, phase separation is less likely to occur. The content of each of MgO, CaO, SrO, and BaO is preferably 0 to 20%, more preferably 1 to 17%, still more preferably 3 to 15%, yet still more preferably 4 to 13%, even still more preferably 5 to 12%, and particularly preferably 6.5 to 12%. In containing at least two components selected from among MgO, CaO, SrO, and BaO in the glass base material, the total content of them is preferably 0 to 20%, more preferably 1 to 17%, still more preferably 3 to 15%, yet still more preferably 4 to 13%, even still more preferably 5 to 12%, and particularly preferably 6.5 to 12%. Among these RO components, CaO is preferably used in view of its particularly large effect of increasing the alkali resistance of the porous glass member.

The glass base material for a porous glass member according to the present invention may contain, in addition to the above components, the following components.

ZnO is a component that increases the content of ZrO₂ in a silica-rich phase. ZnO also has the effect of increasing the weather resistance of the porous glass member. The content of ZnO is preferably 0 to 20%, more preferably 0 to 10%, and particularly preferably 0 to below 3%. If the content of ZnO is too large, phase separation is less likely to occur.

P₂O₅ is a component that promotes phase separation. The content of P₂O₅ is preferably 0 to 10%, more preferably 0.01 to 5%, and particularly preferably 0.05 to 2%. If the content of P₂O₅ is too large, crystallization may occur.

The glass base material may contain La₂O₃, Ta₂O₅, TeO₂, Nb₂O₅, Gd₂O₃, Y₂O₃, Eu₂O₃, Sb₂O₃, SnO₂, Bi₂O₃, and so on, each preferably in a range of 15% or less, more preferably 10% or less, particularly preferably 5% or less, and in a range of 30% or less in total content.

PbO is a substance of environmental concern and, therefore, the glass base material is preferably substantially free of this component. Herein, “substantially free of” means that this component is not deliberately incorporated as a raw material into the glass base material and, objectively, means that the content thereof is less than 0.1%.

Preferred composition examples of the glass base material are described below.

The glass base material preferably contains, in terms of % by mole, 45 to 75% SiO₂, 10 to 30% B₂O₃, 0 to 15% Li₂O, over 0 to 20% Na₂O, over 0 to 5% K₂O, 0 to 20% Li₂O+Na₂O+K₂O, 0.2 to 0.5 (Li₂O+Na₂O+K₂O)/B₂O₃, 0.1 to 0.5 Na₂O/B₂O₃, 0 to 0.16 Li₂O/Na₂O, 0.1 to 8% TiO₂, 2 to 15% ZrO₂, 0.04 to 50 SiO₂/ZrO₂, over 0 to 25% TiO₂+ZrO₂, 0.1 to 7% Al₂O₃, 1 to 17% RO (where R represents at least one selected from among Mg, Ca, Sr, and Ba), 0 to 20% ZnO, 0 to 10% P₂O₅, 15% or less La₂O₃, 15% or less Ta₂O₅, 15% or less TeO₂, 15% or less Nb₂O₅, 15% or less Gd₂O₃, 15% or less Y₂O₃, 15% or less Eu₂O₃, 15% or less Sb₂O₃, 15% or less SnO₂, 15% or less Bi₂O₃, and below 0.1% PbO.

The glass base material preferably contains, in terms of % by mole, 47 to 65% SiO₂, 15 to 25% B₂O₃, 0 to 10% Li₂O, 3 to 15% Na₂O, 0.3 to 3% K₂O, 2 to 15% Li₂O+Na₂O+K₂O, 0.29 to 0.45 (Li₂O+Na₂O+K₂O)/B₂O₃, 0.15 to 0.45 Na₂O/B₂O₃, 0 to 0.13 Li₂O/Na₂O, 0.15 to 6% TiO₂, 2.5 to 12% ZrO₂, 0.04 to 30 SiO₂/ZrO₂, 1 to 20% TiO₂+ZrO₂, 1 to 5% Al₂O₃, 3 to 15% RO (where R represents at least one selected from among Mg, Ca, Sr, and Ba), 0 to 10% ZnO, 0.01 to 5% P₂O₅, 10% or less La₂O₃, 10% or less Ta₂O₅, 10% or less TeO₂, 10% or less Nb₂O₅, 10% or less Gd₂O₃, 10% or less Y₂O₃, 10% or less Eu₂O₃, 10% or less Sb₂O₃, 10% or less SnO₂, 10% or less Bi₂O₃, and below 0.1% PbO.

The glass base material preferably contains, in terms of % by mole, 50 to 60% SiO₂, 15 to 25% B₂O₃, 0 to 10% Li₂O , 4 to 10% Na₂O, 0.3 to 3% K₂O, 4 to 12% Li₂O+Na₂O+K₂O, 0.31 to 0.42 (Li₂O+Na₂O+K₂O)/B₂O₃, 0.2 to 0.4 Na₂O/B₂O₃, 0 to 0.10 Li₂O/Na₂O, 0.15 to 6% TiO₂, 2.5 to 12% ZrO₂, 0.04 to 25 SiO₂/ZrO₂, 3 to 20% TiO₂+ZrO₂, 1 to 5% Al₂O₃, 4 to 13% RO (where R represents at least one selected from among Mg, Ca, Sr, and Ba), 0 to below 3% ZnO, 0.05 to 2% P₂O₅, 5% or less La₂O₃, 5% or less Ta₂O₅, 5% or less TeO₂, 5% or less Nb₂O₅, 5% or less Gd₂O₃, 5% or less Y₂O₃, 5% or less Eu₂O₃, 5% or less Sb₂O₃, 5% or less SnO₂, 5% or less Bi₂O₃, and below 0.1% PbO.

The glass base material preferably contains, in terms of % by mole, 50 to 60% SiO₂, 15 to 25% B₂O₃, 0 to 10% Li₂O, 4 to 10% Na₂O, 0.3 to 3% K₂O, 5 to 10% Li₂O+Na₂O+K₂O, 0.33 to 0.42 (Li₂O+Na₂O+K₂O)/B₂O₃, 0.2 to 0.4 Na₂O/B₂O₃, 0 to 0.10 Li₂O/Na₂O, 0.15 to 6% TiO₂, 2.5 to 12% ZrO₂, 0.04 to 25 SiO₂/ZrO₂, 3 to 20% TiO₂+ZrO₂, 1 to 5% Al₂O₃, 5 to 12% RO (where R represents at least one selected from among Mg, Ca, Sr, and Ba), 0 to below 3% ZnO, 0.05 to 2% P₂O₅, 30% or less La₂O₃+Ta₂O₅+TeO₂+Nb₂O₅+Gd₂O₃+Y₂O₃+Eu₂O₃+Sb₂O₃+SnO₂+Bi₂O₃, and below 0.1% PbO.

The glass base material preferably contains, in terms of % by mole, 50 to 60% SiO₂, 15 to 25% B₂O₃, 0.2 to 10% Li₂O, 4 to 10% Na₂O, 0.3 to 3% K₂O, 5 to 10% Li₂O+Na₂O+K₂O, 0.33 to 0.42 (Li₂O+Na₂O+K₂O)/B₂O₃, 0.2 to 0.4 Na₂O/B₂O₃, 0 to 0.10 Li₂O/Na₂O, 0.15 to 6% TiO₂, 2.5 to 12% ZrO₂, 0.04 to 25 SiO₂/ZrO₂, 3 to 20% TiO₂+ZrO₂, 1 to 5% Al₂O₃, 6.5 to 12% RO (where R represents at least one selected from among Mg, Ca, Sr, and Ba), 0 to below 3% ZnO, 0.05 to 2% P₂O₅, 30% or less

La₂O₃+Ta₂O₅+TeO₂+Nb₂O₅+Gd₂O₃+Y₂O₃+Eu₂O₃+Sb₂O₃+SnO₂+Bi₂O₃, and below 0.1% PbO.

A glass batch formulated to give each of the above glass compositions is melted, for example, at 1300 to 1600° C. for 4 to 12 hours. Subsequently, the molten glass is formed into a shape and then annealed, for example, at 400 to 600° C. for 10 minutes to 10 hours, thus obtaining a glass base material. The shape of the obtained glass base material is not particularly limited, but is preferably a platy shape having a rectangular or circular planar figure. In order to make the obtained glass base material into a desired shape, the glass base material may be subjected to processing, such as cutting or polishing.

The obtained glass base material preferably has an aspect ratio of 2 to 1000 and particularly preferably 5 to 500. If the aspect ratio is too small, this creates a large difference in etching rate between the surface and inside of the glass base material in the step of removing (etching) a boron oxide-rich phase with an acid. Therefore, stress is likely to be produced in the inside of the porous glass member and the porous glass member is thus likely to crack. On the other hand, if the aspect ratio is too large, the glass base material is difficult to handle.

The base area and thickness of the obtained glass base material may be appropriately adjusted to give the above aspect ratio. For example, the base area is preferably 1 to 1000 mm² and particularly preferably 5 to 500 mm² and the thickness is preferably 0.1 to 1 mm and particularly preferably 0.2 to 0.5 mm.

Next, the obtained glass base material is subjected to thermal treatment to separate (spinodally separate) it into two phases: a silica-rich phase and a boron oxide-rich phase. The temperature for the thermal treatment is preferably 500 to 800° C. and particularly preferably 600 to 750° C. If the temperature for the thermal treatment is too high, the glass base material softens and is therefore less likely to have a desired shape. On the other hand, if the temperature for the thermal treatment is too low, the glass base material is less likely to undergo phase separation. The time for the thermal treatment is preferably one minute or more, more preferably ten minutes or more, and particularly preferably 30 minutes or more. If the time for the thermal treatment is too short, the glass base material is less likely to undergo phase separation. The upper limit of the time for the thermal treatment is not particularly limited. However, even if the glass base material is thermally treated for a long time, phase separation does not progress beyond a certain level. Therefore, the time for the thermal treatment is actually not more than 180 hours.

Next, the glass base material separated into two phases is immersed into an acid to remove the boron oxide-rich phase, thus obtaining a porous glass member. The acid that can be used is hydrochloric acid or nitric acid. These acids may be used in mixture. The concentration of the acid is preferably 0.1 to 5 N and particularly preferably 0.5 to 3 N. The time for immersion in the acid is preferably an hour or more, more preferably 10 hours or more, and particularly preferably 20 hours or more. If the time for immersion is too short, etching is insufficient, which makes it difficult to obtain a porous glass member having desired interconnected pores. The upper limit of the time for immersion is not particularly limited, but it is actually not more than 100 hours. The temperature during immersion is preferably 20° C. or higher, more preferably 25° C. or higher, and particularly preferably 30° C. or higher. If the temperature during immersion is too low, etching is insufficient, which makes it difficult to obtain a porous glass member having desired interconnected pores. The upper limit of the temperature during immersion is not particularly limited, but it is actually not higher than 95° C.

In the step of separating the glass base material into phases, a silica-containing layer (a layer containing silica in a content of approximately 80% by mole or more) may be formed in the uppermost portion of the surface of the glass base material. The silica-containing layer is difficult to remove with an acid. Therefore, if a silica-containing layer has been formed, the glass base material separated into phases is cut or polished to remove the silica-containing layer and then immersed into an acid. In this way, the boron oxide-rich phase can be easily removed. Alternatively, in order to remove the silica-containing layer, the glass base material separated into phases may be immersed into hydrofluoric acid for a short time.

Furthermore, it is preferred to remove residual ZrO₂ colloid and SiO₂ colloid in the pores of the obtained porous glass.

ZrO₂ colloid can be removed, for example, by immersing the glass base material into sulfuric acid. The concentration of sulfuric acid is preferably 0.1 to 5 N and particularly preferably 1 to 5 N. The time for immersion into sulfuric acid is preferably an hour or more and particularly preferably 10 hours or more. If the time for immersion is too short, ZrO₂ colloid is less likely to be removed. The upper limit of the time for immersion is not particularly limited, but it is actually not more than 100 hours. The temperature during immersion is preferably 20° C. or higher, more preferably 25° C. or higher, and particularly preferably 30° C. or higher. If the temperature during immersion is too low, ZrO₂ colloid is less likely to be removed. The upper limit of the temperature during immersion is not particularly limited, but it is actually not higher than 95° C.

SiO₂ colloid can be removed, for example, by immersing the glass base material into an aqueous alkaline solution. Examples of the aqueous alkaline solution that can be used include sodium hydroxide aqueous solution and potassium hydroxide aqueous solution. These aqueous alkaline solutions may be used in mixture. The time for immersion into the aqueous alkaline solution is preferably 10 minutes or more and particularly preferably 30 minutes or more. If the time for immersion is too short, SiO₂ colloid is less likely to be removed. The upper limit of the time for immersion is not particularly limited, but it is actually not more than 100 hours. The temperature during immersion is preferably 15° C. or higher and particularly preferably 20° C. or higher. If the temperature during immersion is too low, SiO₂ colloid is less likely to be removed. The upper limit of the temperature during immersion is not particularly limited, but it is actually not higher than 95° C.

As necessary, the obtained porous glass member may be subjected to washing treatment with ion-exchange water or the like. In this case, in order for the porous glass member to be prevented from cracking when dried, the member having undergone the washing treatment is preferably immersed into a solvent having a small surface tension, such as ethanol, methanol or 2-propanol, to substitute water attached to the surface of the member with the solvent.

The obtained porous glass member preferably contains, in terms of % by mass, 50 to 99% (more preferably 55 to 94%) SiO₂, 0 to 15% (more preferably 0 to 10%, particularly preferably 0.1 to 10%) Na₂O, 0 to 5% (more preferably 0 to 3%) K₂O, over 0 to 10% (more preferably 0.01 to 5%, particularly preferably 0.1 to 5%) TiO₂, over 0 to 30% (more preferably 1 to 28%) ZrO₂, over 0 to 15% (more preferably 0.1 to 10%) Al₂O₃, and 0 to 5% (more preferably 0.1 to 3%) RO (where R represents at least one selected from among Mg, Ca, Sr, and Ba) . The obtained porous glass member may contain, in addition to these components, 0 to 5% (more preferably 0 to 4.9%, still more preferably 0.05 to 4.9%, particularly preferably 0.05 to 3%) P₂O₅. When, as just described, the porous glass member contains respective predetermined amounts of SiO₂ and ZrO₂, the porous glass member can achieve excellent alkali resistance.

The median value of the pore distribution of the porous glass member is preferably 1 μμm or less, more preferably 200 nm or less, still more preferably 150 nm or less, yet still more preferably 120 nm or less, even more preferably 100 nm or less, even still more preferably 90 nm or less, even yet still more preferably 80 nm or less, and particularly preferably 70 nm or less. The lower limit of the median value of the pore distribution is not particularly limited, but it is actually preferably not less than 1 nm, more preferably not less than 2 nm, and still more preferably not less than 4 nm. Examples of the pore shape include a continuum of spherical pores, a continuum of approximately ellipsoidal pores, and a tubular shape.

The aspect ratio, base area, thickness, and other dimensions of the porous glass member are the same as those of the glass base material. Specifically, the aspect ratio of the porous glass member is preferably 2 to 1000 and particularly preferably 5 to 500. The base area of the porous glass member is preferably 1 to 1000 mm² and particularly preferably 5 to 500 mm² and the thickness thereof is preferably 0.1 to 1 mm and particularly preferably 0.2 to 0.5 mm.

### EXAMPLES

Hereinafter, the present invention will be described with reference to examples, but is not limited to these examples.

Tables 1 to 3 show examples (Sample Nos. 1 to 17) of the present invention and comparative examples (Sample Nos. 18 and 19).

TABLE 1

| | | 1 | 2 | 3 | 4 | 5 | 6 | 7 |
|---|---|---|---|---|---|---|---|---|
| Glass Base Material | SiO₂ | 56.02 | 54.52 | 55.1 | 55.02 | 56.6 | 53.6 | 58.44 |
| (% by mole) | Al₂O₃ | 2 | 2 | 2 | 2 | 2 | 2 | 2 |
| | B₂O₃ | 20 | 20 | 20 | 20 | 18 | 18 | 16.4 |
| | Li₂O | | | | | | | |
| | Na₂O | 7.4 | 7.4 | 7.4 | 6.4 | 6.3 | 6.3 | 4.96 |
| | K₂O | | | | 1 | 0.45 | 0.45 | 1.35 |
| | CaO | 9.5 | 9.5 | 9.5 | 9.5 | 8.55 | 8.55 | 7.2 |
| | ZrO₂ | 3 | 3 | 3 | 3 | 5 | 7 | 8 |
| | P₂O₅ | 0.08 | 0.08 | | 0.08 | 0.1 | 0.1 | 0.15 |
| | TiO₂ | 2 | 3.5 | 3 | 3 | 3 | 4 | 1.5 |
| | Li₂O + Na₂O + K₂O | 7.4 | 7.4 | 7.4 | 7.4 | 6.75 | 6.75 | 6.31 |
| | (Li₂O + Na₂O + K₂O)/B₂O₃ | 0.37 | 0.37 | 0.37 | 0.37 | 0.38 | 0.38 | 0.38 |
| | Na₂O/B₂O₃ | 0.37 | 0.37 | 0.37 | 0.32 | 0.35 | 0.35 | 0.30 |
| | Li₂O/Na₂O | | | | | | | |
| | SiO₂/ZrO₂ | 18.7 | 18.2 | 18.4 | 18.3 | 11.3 | 7.7 | 7.3 |
| | TiO₂ + ZrO₂ | 5 | 6.5 | 6 | 6 | 8 | 11 | 9.5 |
| Porous Glass Member | SiO₂ | 82.6 | 80.1 | 84.6 | 82.5 | 80.6 | 88.9 | 79.5 |
| (% by mass) | Al₂O₃ | 4.5 | 4.7 | 3.9 | 4.7 | 3.8 | 0.8 | 2.4 |
| | Li₂O | | | | | | | |
| | Na₂O | 5.7 | 7.5 | 4.9 | 5.1 | 4.3 | 1.9 | 4.7 |
| | K₂O | | | | | | | |
| | CaO | 0.1 | | | | 0.2 | | 0.2 |
| | ZrO₂ | 6.0 | 6.1 | 5.2 | 6.0 | 9.1 | 5.7 | 10.9 |
| | P₂O₅ | | 0.1 | | 0.1 | 0.3 | 1.4 | 1.4 |
| | TiO₂ | 1.1 | 1.5 | 1.4 | 1.6 | 1.7 | 1.3 | 0.9 |
| | Etching Rate (μm/h) | 5.2 | 5.2 | 5.2 | 5.2 | 3.75 | 5 | 3.3 |
| | Alkali resistance | good | good | good | good | good | good | good |

TABLE 2

| | | 8 | 9 | 10 | 11 | 12 | 13 | 14 |
|---|---|---|---|---|---|---|---|---|
| Glass Base Material | SiO₂ | 50.1 | 56.99 | 55.1 | 55.1 | 58.5 | 57.85 | 58.35 |
| (% by mole) | Al₂O₃ | 2 | 2 | 2 | 2 | 1.7 | 1.7 | 2 |
| | B₂O₃ | 18 | 16 | 18 | 18 | 17 | 17 | 17 |
| | Li₂O | | | 0.35 | 0.5 | 0.3 | | |
| | Na₂O | 6.3 | 4.84 | 5.95 | 5.8 | 5.4 | 5.8 | 5.7 |
| | K₂O | 0.45 | 1.32 | 0.45 | 0.45 | 0.8 | 0.8 | 0.8 |
| | CaO | 8.55 | 7.2 | 8.55 | 8.55 | 8.5 | 9 | 9 |
| | ZrO₂ | 9.5 | 10 | 6 | 6 | 6 | 6 | 6 |
| | P₂O₅ | 0.1 | 0.15 | 0.1 | 0.1 | 0.1 | 0.15 | 0.15 |
| | TiO₂ | 5 | 1.5 | 3.5 | 3.5 | 1.7 | 1.7 | 1 |
| | Li₂O + Na₂O + K₂O | 6.75 | 6.16 | 6.75 | 6.75 | 6.2 | 6.6 | 6.5 |
| | (Li₂O + Na₂O + K₂O)/B₂O₃ | 0.38 | 0.39 | 0.38 | 0.38 | 0.36 | 0.39 | 0.38 |
| | Na₂O/B₂O₃ | 0.35 | 0.30 | 0.33 | 0.32 | 0.32 | 0.34 | 0.34 |
| | Li₂O/Na₂O | | | 0.06 | 0.09 | 0.06 | 0.00 | |
| | SiO₂/ZrO₂ | 5.3 | 5.7 | 9.2 | 9.2 | 9.8 | 9.6 | 9.7 |
| | TiO₂ + ZrO₂ | 14.5 | 11.5 | 9.5 | 9.5 | 7.7 | 7.7 | 7 |
| Porous Glass Member | SiO₂ | 90.2 | 58.7 | 87.9 | 87.3 | 83.9 | 85.7 | 86.1 |
| (% by mass) | Al₂O₃ | 0.6 | 4.8 | 2.0 | 2.7 | 2.8 | 2.5 | 1.6 |
| | Li₂O | | | | | | | |
| | Na₂O | 0.7 | 4.8 | | | | | |
| | K₂O | | 0.5 | | | | | |
| | CaO | 0.6 | 0.9 | | 0.1 | 0.3 | 0.1 | |
| | ZrO₂ | 4.9 | 26.8 | 8.7 | 8.0 | 10.5 | 10.2 | 9.80 |
| | P₂O₅ | | 0.9 | 0.4 | 0.7 | 1.6 | 0.7 | 2.0 |
| | TiO₂ | 3.0 | 2.6 | 0.9 | 1.2 | 0.9 | 0.8 | 0.5 |
| | Etching Rate (μm/h) | 6.7 | 10.4 | 6.7 | 8.75 | 8.33 | 10.4 | 10.4 |
| | Alkali resistance | good | good | good | good | good | good | good |

TABLE 3

| | | 15 | 16 | 17 | 18 | 19 |
|---|---|---|---|---|---|---|
| Glass | SiO₂ | 59.3 | 57.21 | 57.92 | 55.85 | 65.16 |
| Base | Al₂O₃ | 2 | 1.9 | 1.5 | 2 | |
| Material | B₂O₃ | 16 | 15 | 15 | 20 | 24.93 |
| (% by | Li₂O | | | | | |
| mole) | Na₂O | 5.5 | 5 | 5 | 7 | 9.91 |
| | K₂O | 0.8 | 1 | 0.75 | | |
| | CaO | 10 | 9.4 | 9.4 | 9 | |
| | ZrO₂ | 6 | 10 | 10 | 6 | |
| | P₂O₅ | 0.15 | 0.26 | 0.24 | 0.15 | |
| | TiO₂ | 0.25 | 0.23 | 0.19 | | |
| | Li₂O + Na₂O + K₂O | 6.3 | 6 | 5.75 | 7 | 9.91 |
| | (Li₂O + Na₂O + K₂O)/B₂O₃ | 0.39 | 0.40 | 0.38 | 0.35 | 0.40 |
| | Na₂O/B₂O₃ | 0.34 | 0.33 | 0.33 | 0.35 | 0.40 |
| | Li₂O/Na₂O | | | | | |
| | SiO₂/ZrO₂ | 9.9 | 5.7 | 5.8 | 9.3 | — |
| | TiO₂ + ZrO₂ | 6.25 | 10.23 | 10.19 | 6 | 0 |
| Porous | SiO₂ | 85.7 | 78.5 | 74.6 | 94.2 | 99.9 |
| Glass | Al₂O₃ | 2.5 | 2.8 | 2.6 | 0.7 | |
| Member | Li₂O | | | | | |
| (% by | Na₂O | | 0.1 | 0.4 | 0.1 | 0.1 |
| mass) | K₂O | | 0.1 | 0.2 | | |
| | CaO | 0.1 | 0.6 | 0.7 | 0.1 | |
| | ZrO₂ | 9.6 | 15.1 | 16.8 | 3.7 | |
| | P₂O₅ | 2.0 | 2.7 | 4.6 | 1.2 | |
| | TiO₂ | 0.1 | 0.1 | 0.1 | | |
| | Etching Rate (μm/h) | 10.4 | 5.2 | 10.4 | 0.9 | 10.4 |
| | Alkali resistance | good | good | good | good | poor |

Raw materials formulated to give each of the compositions in the tables were put into a platinum crucible and then melted therein at 1400° C. to 1500° C. for four hours. During melting of the glass batch, it was stirred using a platinum stirrer to homogenize it. Next, the molten glass was poured onto a metallic plate to form it into a platy shape and then annealed at 580° C. to 540° C. for 30 minutes, thus obtaining a glass base material.

The obtained glass base material was cut and polished to a size of 5 mm×5 mm×0.5 mm. Next, the glass base material was thermally treated in an electric furnace at 500° C. to 800° C. for 10 minutes to 24 hours to separate it into two phases: a silica-rich phase and a boron oxide-rich phase. The glass base material separated into phases was immersed into 1 N nitric acid (at 95° C.) for 48 to 96 hours to etch away the boron oxide-rich phase and form pores and then washed with ion-exchange water. Subsequently, residual colloid in the pores of the obtained member was removed. Specifically, the porous glass member was immersed into 3 N sulfuric acid (at 95° C.) for 48 to 96 hours, then washed with ion-exchange water, subsequently immersed into 0.5 N sodium hydroxide aqueous solution (at room temperature) for 3 hours to 5 hours, then washed with ion-exchange water, then immersed into 2-propanol, and then picked up from the 2-propanol. In this manner, a porous glass member was obtained.

When the cross sections of the obtained porous glass members were observed with an FE-SEM (SU-8220 manufactured by Hitachi, Ltd.), all the glass members had a skeleton structure based on spinodal decomposition. Furthermore, the value obtained by dividing the maximum depth of the pores in the porous glass member by the etching time of 48 to 96 hours was evaluated as the etching rate.

Next, the porous glass members were analyzed with EDX (EX-370X-Max^{N}150 manufactured by Horiba, Ltd.) to measure the respective compositions of the porous glass members. The analysis was conducted on three points of a central portion of the cross section of each porous glass member and the average of the three measured values was adopted.

Furthermore, each porous glass member was evaluated in terms of alkali resistance in the following manner. The porous glass member was immersed into 0.5 N sodium hydroxide aqueous solution held at 80° C. for 20 minutes. With respect to the amount of weight reduction per specific surface area between before and after the immersion, the members having an amount of weight reduction of less than 3 mg/m² were evaluated as “good” and the member having an amount of weight reduction of 3 mg/m² or more was evaluated as “poor”. The specific surface area was measured with QUADRASORB SI manufactured by Quantachrome Instruments.

As for Sample Nos. 1 to 17 which are examples of the present invention, the etching rate during the acidic treatment was as large as 3.3 to 10.4 μm/h and the obtained porous glass members had excellent weather resistance. In contrast, as for Sample No. 18 which is a comparative example, the etching rate was as small as 0.9 μm/h. As for Sample No. 19, the obtained porous glass member had poor weather resistance.

### INDUSTRIAL APPLICABILITY

The porous glass member produced by the method according to the present invention is suitable for various applications, including a separation membrane, a diffuser tube, an electrode material, and a catalyst support.

1. A method for producing a porous glass member, the method comprising the steps of: subjecting a glass base material containing, in terms of % by mole, 40 to 80% SiO₂, over 0 to 40% B₂O₃, 0 to 20% Li₂O, 0 to 20% Na₂O, 0 to 20% K₂O, over 0 to 10% TiO₂, over 0 to 20% ZrO₂, 0 to 10% Al₂O₃, and 0 to 20% RO (where R represents at least one selected from among Mg, Ca, Sr, and Ba) and having a molar ratio of Li₂O/Na₂O of 0 to 0.16 to thermal treatment to separate the glass base material into two phases; and removing one of the two phases with an acid.

2. The method for producing a porous glass member according to claim 1, wherein the glass base material has an aspect ratio of 2 to 1000.

3. The method for producing a porous glass member according to claim 1, wherein a temperature for the thermal treatment is 500 to 800° C.

4. A glass base material for a porous glass member, the glass base material containing, in terms of % by mole, 40 to 80% SiO₂, over 0 to 40% B₂O₃, 0 to 20% Li₂O, 0 to 20% Na₂O, 0 to 20% K₂O, over 0 to 10% TiO₂, over 0 to 20% ZrO₂, 0 to 10% Al₂O₃, and 0 to 20% RO (where R represents at least one selected from among Mg, Ca, Sr, and Ba) and having a molar ratio of Li₂O/Na₂O of 0 to 0.16.

5. A porous glass member containing, in terms of % by mass, 50 to 99% SiO₂, 0 to 15% Na₂O, 0 to 5% K₂O, over 0 to 10% TiO₂, over 0 to 30% ZrO₂, over 0 to 15% Al₂O₃, and 0 to 5% RO (where R represents at least one selected from among Mg, Ca, Sr, and Ba).
